(19) United States
(12) Patent Application Publication
(10) Pub. No.: US 2019/0373358 A1
(43) Pub. Date: Dec. 5, 2019

(54) SYSTEMS AND METHODS FOR HEADPHONES WITH MULTIPLE SPEAKER CONFIGURATIONS

(71) Applicant: John C. Zarganis, San Mateo, CA (US)

(72) Inventor: John C. Zarganis, San Mateo, CA (US)

(73) Assignee: Sony Interactive Entertainment LLC, San Mateo, CA (US)

(21) Appl. No.: 15/995,916

(22) Filed: Jun. 1, 2018

(51) Int. Cl. H04R 1/10; H04R 1/40

(52) U.S. Cl. CPC H04R 1/1075; H04R 1/1008; H04R 1/403; H04R 1/1066; H04R 1/1083

(57) ABSTRACT

The present disclosure relates to systems, methods, and devices for headphone speakers. In one embodiment, headphone speaker system is provided including a headset unit and an earphone pair. The headset unit and earphone pair are reconfigurable and module sound emitting units that allow for multiple arrangements, including output of audio signals to both the head set unit and the earphone pair, or selective output of audio to one of the head set unit and earphone pair. The headset unit is configured to include ear cups that allow for mounting the earphone pair in one or more positions. The headset unit can charge the earphone pair. In some embodiments, a headphone system is provided including earphone speakers that may be inserted within ear cups and that operate either independently or combined with headset speakers. Processes and device configurations are provided for selective output of audio to speaker systems and headset unit.

### FIELD

The present disclosure relates to electronic devices and system configurations, and more particularly to headphone speaker systems.

### BACKGROUND

Headphones generally include a two speaker configuration, with each speaker arranged to provide audio output to a user's ear. There are many existing headphone configurations. By way of example, over the ear headphones are traditionally big and bulky and are often directed towards providing a blend of comfort, sound quality and performance which may not always be required. One drawback of existing headphone configurations is that all conventional designs provide an input to one pair of speakers. There exists a desire for a configurable headphone design that allows for more than a single configuration. There is also a desire to provide headphone design which allows for multiple applications with enhance portability and mobility during use.

### BRIEF SUMMARY OF THE EMBODIMENTS

Disclosed and claimed herein are systems, methods and devices for headphones. One embodiment is directed to a headphone speaker system including a headset unit including a first speaker system, wherein the headset unit is an over the ear headset including a pair of ear cup units to house the first speaker system, and a second speaker system including an earphone pair. The headphone speaker system also includes a control unit configured to direct audio output to at least one of the first speaker system and the second speaker system.

In one embodiment, the headset unit includes a speaker driver in each of the ear cup units, and wherein the headset unit is configured to emit sound from the speaker driver in each of the ear cup units.

In one embodiment, the headset unit is configured to retain each speaker driver of the earphone pair within a respective ear cup unit.

In one embodiment, the headset unit is configured to charge the earphone pair when mounted to the headset unit.

In one embodiment, the headset unit includes a mount configured to retain the second speaker system to an external surface of the ear cups.

In one embodiment, the second speaker system is configured for independent operation relative to the headset unit.

In one embodiment, the control unit directs audio output to both the first speaker system and the second speaker system, and wherein the first speaker system and second speaker system each emit sound.

In one embodiment, the control unit is configured to direct audio output to the second speaker system when the earphone pair is mounted within the ear cup units.

In one embodiment, the control unit directs audio output to the first speaker system when the earphone pair of the second speaker system is mounted to an external surface of the ear cup units.

Another embodiment is directed to a headphone speaker system including an earphone speaker system including an earphone pair. The earphone speaker system includes a control unit configured to direct audio output to the earphone pair. The system also includes a headset unit, wherein the headset unit is an over the ear headset including a pair of ear cup units, and wherein the headset unit is configured to removably retain the earphone speaker system within the pair of ear cup units.

In one embodiment, the headset unit includes a speaker driver in each of the ear cup units, and wherein the headset unit is configured to emit sound from the speaker driver in each of the ear cup units.

In one embodiment, the headset unit is configured to retain each speaker driver of the earphone pair within the pair of ear cups.

In one embodiment, the headset unit is configured to charge the earphone pair when mounted to the headset unit.

In one embodiment, the headset unit includes a mount configured to retain the second speaker system to an external surface of the ear cups.

In one embodiment, the second speaker system is configured for independent operation relative to the headset unit.

In one embodiment, the control unit directs audio output to both the headset speaker system and the earphone speaker system, and wherein the headset speaker system and earphone speaker system each emit sound.

Another embodiment is directed to a headphone speaker system including a headset unit including a first speaker system and a first control unit, wherein the headset unit is an over the ear headset including a pair of ear cup units to house the first speaker system. The first control unit is configured to direct audio output to the first speaker system. The system also includes a second speaker system including an earphone pair and a second control unit, the second control unit is configured to direct audio output to the second speaker system. The first control unit and second control unit coordinate audio output for the headphone speaker system.

In one embodiment, the headset unit includes a speaker driver in each of the ear cup units, and wherein the headset unit is configured to emit sound from the speaker driver in each of the ear cup units.

In one embodiment, the headset unit is configured to retain each speaker driver of the earphone pair within a respective ear cup unit.

In one embodiment, the first control unit and second control unit direct audio output based on an arrangement of the earphone pair relative to the headset unit.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a system diagram according to one or more embodiments;

FIG. 2 depicts a process for headphone operation according to one or more embodiments;

FIGS. 3A and 3B depicts headphone configurations according to another embodiment;

FIG. 4A depicts a graphical representation of an earphone pair according to one or more embodiments;

FIG. 4B depicts a graphical representation of a headphone system including a headset unit and earphone pair according to one or more embodiments;

FIG. 4C depicts a graphical representation of a headphone system including a headset unit and earphone pair according to one or more other embodiments;

FIG. 4D depicts a graphical representation of a headset unit of a headphone system according to one or more other embodiments; and

FIG. 4E depicts a graphical representation of a headset unit configuration of a headphone system according to one or more other embodiments.

### DETAILED DESCRIPTION OF THE EXEMPLARY EMBODIMENTS

### Overview and Terminology

One aspect of the disclosure is directed to providing a headphone system that is configurable. In one embodiment, a headphone system is provided including a headset unit having a first speaker system, and a second speaker system including an earphone pair. The headset unit may be configured to allow for mounting of the earphone pair within ear cup units of the headset unit to allow for audio output by both the first speaker system and the second speaker system. In one embodiment, the earphone pair is configured to separate from the headset apparatus and be used independently to enhance portability and mobility during use. Systems, methods and devices described herein are provided for selective output to the first speaker system and second speaker system.

In one embodiment, a headphone system is provided including a headset configured to allow for mounting of an earphone pair relative to one or more locations of the headset unit. In one embodiment, the headset unit may be configured to removably retain the earphone pair within cup units (e.g., over the ear elements) of the head set. As such, the earphone pair may be retained to allow for insertion to a user's ears and/or positioning in close proximity to the users ear canal. The earphone pair may be removable to allow for use independent from the headset. According to another embodiment, the headset may be configured to allow for mounting of the earphone pair to an outer surface of the headset. In certain embodiments, the headset unit may be configured store the earphone speakers. According to another embodiment, the headset unit may be configured to charge the earphone pair of the second speaker system. Processes are provided for audio output to one or more speaker systems of the headphone system.

Another embodiment is provided for a configuration that allows for use of an earphone system (e.g., ear buds, in ear headphones, etc.) with a headset unit. In one embodiment, a headset unit may be provided to suppress ambient sound. The headset unit may provide one or more elements, such as ear cup units to suppress ambient sound. The head set unit may be configured to provide active noise cancelation. In one embodiment, the speaker system associated with the earphone pair may be used either inside the head set unit, or removed and used separately. As such the head set unit can enhance the ability of a single user to listen to audible sound and also minimize the user’ ability to hear unwanted ambient or external noise.

Another embodiment is directed to device configurations and processes to allow for direction audio output to one of a first speaker system and a second speaker system. In certain embodiments, both the first speaker system and the second speaker s system may be controlled to emit audio output. In other embodiments, the first speaker system and the second speaker system may be selectively activated based on the position of the earphone pair.

A headphone relates to one or more devices that include a speaker configuration that may be worn, over the user's ear with full or partial coverage, as earbuds with a portion of the speakers inserted into a user's ear canal. According to one embodiment, a headphone as described herein relates to a wearable device, to allow for audio output relative to the users ears. The headphone systems and configurations discussed herein may receive audio and input data by way of a wired or wireless connection to one or more source devices.

A headset may relate to a structural unit with one or more electrical components and electromechanical components.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### EXEMPLARY EMBODIMENTS

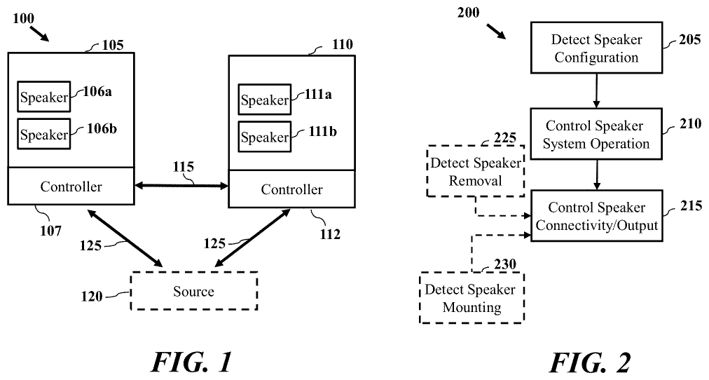

Referring now to the figures, FIG. 1 depicts a system diagram according to one or more embodiments. According to one embodiment, system 100 relates to a headphone system including a first speaker system 105 and a second speaker system 110. According to one embodiment, at least one of first speaker system 105 and second speaker system 110 is activated to output audio data.

System 100 provides a convertible and configurable headphone system that includes a combination of earphone speakers of second speaker system 110 that may be worn in contact with, or near, a user's ear and a headset configuration of the first speaker system 110 to be worn on or around a user's head. In one embodiment, the earphone speakers of the second speaker system 110 are configured to convey sound received from a source device. The headset apparatus may be provided to locate and retain the position of the earphone speakers. Headset systems as discussed herein locate and retain the position of the earphone speakers to a user's ears.

According to one embodiment, system 100 relates to a headphone system allow for selective operation of first speaker system 105 and second speaker system 110. By providing selective operation, system 100 provides a convertible and configurable headphone device that can allow for one or more combinations of output speakers. As shown in FIG. 1, first speaker system 105 includes speakers 106a-106b and controller 107. Similarly, second speaker system 110 includes speakers 111a-111b and controller 112. In one embodiment, controllers 107 and 112 may be configured to selectively driver speakers 106a-106b and speakers 111a-111b together or independently.

Controller 107 and controller 112 may be configured to communicate for at least one of control and for combined output of audio sound. As shown in FIG. 1, communications link 115 between first speaker system 105 and second speaker system 110 may allow for selective operation of speakers. In certain embodiments, communication link 115 may be used to coordinate output of speakers 106a-106b and speakers 111a-111b.

Output of first speaker system 105 and second speaker system 110 may be based on e content received from one or more sources, such as a media player, gaming console, display device, portable computing device, mobile electronic device (e.g., smart phone, etc.) and electronic or computing devices in general. FIG. 1 depicts content being provided by optional source 120. Optional source 120 may be a separate device that provides audio data 125 for output. System 100 may receive audio data from one or more devices by way of wired and/or wireless data. System 100 may be configured to allow controllers to communicate by way of short-range wireless communication (e.g., Bluetooth, Bluetooth LTE, Wi-Fi, WAP, etc.).

According to one embodiment, controllers 107 and 112 each receive audio content. In other embodiments, one controller (e.g., controller 107) may receive audio data 125 and then provide the audio data for output by way of communications link 115 to second speaker system 110. In one embodiment, communication between first speaker system 105 and second speaker system 110 may include wireless communication, wired communication, and a combination of wireless and wired communication. As such, when source is a media player or gaming console, first speaker system 105 and second speaker system 110 may receive audio data by way or a wired or wireless transmission. According to one embodiment, the headphone system is configured to receive sound form external devices by one or more of an auxiliary audio jack (e.g., 3.5 mm), USB, micro-USB, network cable, etc.

According to one embodiment, first speaker system 105 may relate to a headset unit, and second speaker system 110 may relate to a second set of drivers, such as earphone speakers. According to another embodiment, first speaker system 105 may relate to an over the ear headset. According to another embodiment, second speaker system 110 may relate to in-ear speaker units, such as ear buds. As will be discussed herein, a headphone system as discussed herein may include one or more convertible configurations, such as placement of the earbuds within an over the ear headset, removal of the earbuds and even standalone use of the earbuds or other device.

System 100 may provide several benefits. The configuration overcomes existing cumbersome headphones which may not always be required and allow for a more flexible configuration. System 100 may be employed for one or more types of media. By way of non-limiting example, during video game play, video content consumption and/or listening to music, audio books, etc., the user may desire to dampen or eliminate ambient noise to enhance listening experience. As such, a head set unit may be employed. In addition, system 100 allows for smaller and convenient form factors for delivering audio content. System 100 allows for configurations to separate the second speaker system, such as earphone speakers from the headset and use only the earphone pair for sound. This configuration provides more freedom and may be useful for activities associated with exercise, or where there is a desire to not have the over the ear headset.

FIG. 2 depicts a process for headphone operation according to one or more embodiments. Process 200 may allow for a device, or headphone system, to control speaker connectivity and operation. According to one embodiment, process 200 may be executed by one or more speaker controllers (e.g., controller 105, controller 110, etc.). Process 200 includes detecting a speaker configuration at block 205.

According to one embodiment, audio output by a headphone speaker system may be based on the arrangement of an earphone pair relative to the headset. In one embodiment, removal of a second speaker system (e.g., second speaker system 110, earphone pair) from a first speaker system (e.g., first speaker system 105, headset) may result in operation of the second speaker system as a standalone or independent operation. According to another embodiment, mounting of the second speaker system to an outer surface of a headset can result in output of audio only to speaker elements of the headset. In yet another embodiment, arrangement of the second speaker system into ear cups of the headset can result in operation of only the second speaker system, or both the first and second speaker system together. According to one embodiment, speaker configuration at block 205 may be based on a detected user input. In an exemplary embodiment, the user input may be provided to a user interface that allows for selection of the first speaker system, the second speaker system in an independent configuration, the second speaker signal within the headset, and both the headset speakers and the second speaker system. The selection may be based on a graphical interface allowing for the multiple configurations. In certain embodiments, speaker configuration may be detected based on placement of the earphone pair in a docked position to charge in the headset. The first and second speaker configuration may output operation status to a controller. In certain embodiments, the first and second speaker systems exchange operating status and availability by way of controllers. In response to the operating status, a speaker configuration may be detected at block 205.

At block 210, process 200 controls speaker system operation. In one embodiment, each speaker system includes a controller. The controllers may select which speakers to apply audio output to at block 210 based on the detected speaker configuration at block 205.

At block 215, process 200 controls speaker connectivity and output. According to one embodiment, operation of the headphone system may be in response to changes in the arrangement of speaker elements. In response to a detected speaker removal in optional block 225, a controller may activate or deactivate a speaker system. By way of example, removal of an earphone pair associated with the second speaker system may result in operation of the earphone pair independently from the headset unit at block 215. According to another embodiment, removal of an earphone pair associated with the second speaker system at block 225 may result in operation of a first speaker system independently from the second speaker system.

According to one embodiment, process 200 may optionally detect speaker mounting at block 230. According to one embodiment, mounting of an earphone pair to the headset, such as an outer surface of the headset for charging, may result in operation of the first speaker system to output audio. Alternatively, mounting of an earphone pair within ear cups of the headset may result in output of audio to the first speaker system and/or the second speaker system.

Process 200 may be performed by a controller of a speaker system.

In one embodiment, process 200 employed by each of the headset unit and second speaker system. For example, each controller of the speaker system may independently control the respective speaker elements and signal status to each other. According to another embodiment, a single controller of the headphone system may direct operation of the headset unit and earphone pair.

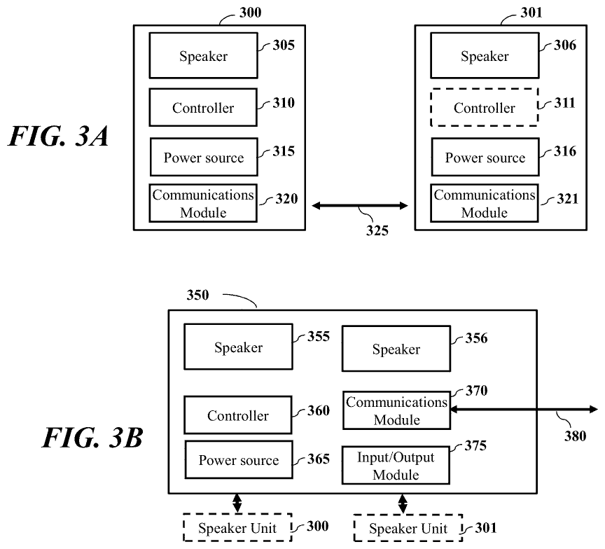

FIGS. 3A and 3B depicts headphone configurations according to one or more embodiments. FIG. 3A shows an exemplary representation of a speaker system such as an earphone pair including earphone units 300 and 301. Earphone unit 300 includes a speaker 305, controller 310, power source 315 and communications module 320. According to one embodiment, earphone unit 301 similarly includes a speaker 306, power sources 316 and communications module 321. Earphone unit 301 includes optional controller 311. In certain configurations, the earphone pair may utilize a single controller between the two devices. In the embodiment of FIG. 3A, earphone pair relates to wireless headphone elements, however, it should be appreciated that wired configurations may be employed.

Earphone units 300 and 301 may communicate to exchange one or more of control data, audio data or control signals in general by way of a link 325, which may be wired or wireless. In one embodiment, controller 310 directs communications module 320 to alert communications module 321 or any changes in the headphone speaker arrangement that require updating.

According to one embodiment, speaker 305 relates to a headphone speaker. Speakers of earphone unit 300 and 301 may be the same type of speaker. In one embodiment speakers 305 and 306 relate to in-ear speakers (e.g. speaker buds, etc.). Controller 310 may relate to a control chip or element configured to direct operation and communication of the second system. Controller 310 and optional controller 311 may each include memory storing executable instructions to perform operations of the second speaker system. Power source 315 may relate to a rechargeable battery. According to one embodiment, at least one of controllers 310 and 311 is configured to connect with a head set unit, such as the head set unit of FIG. 3B to direct and control output of audio data.

Communications module 320 may be configured for sort range wireless communication and/or a wired communication source.

FIG. 3B represents components of a headset system including speakers that interface with a secondary system, such as the speakers of earphone units 300 and 301. Headset unit 350 includes speakers 355 and 356, controller 360, power source 365, communications module 370, and input/output module 375.

Headset unit 350 is configured to interface with one or more sources to provide audio output (e.g., voice communication, videos, etc.). Speakers 355 and 356 may relate to over the ear speaker elements to be fixedly mounted within the headset structure, such as the ear cups of the headset. Controller 360 may relate to a processor and memory, the processor configured to execute operational code stored on memory to receive audio and output audio. Power source 365 may relate to a rechargeable battery. Communications module 370 may be configured to exchange data with a second speaker system such as Earphone units 300 and 301. In certain embodiments, communications module 370 provides the head set unit 350 communication by way of wired or wireless communication shown by 380. In certain embodiments, communication link 380 provides audio data for output by speakers 355 and 356. In other embodiments, communication link 380 may provide control data to, and from, one or more other devices. According to one embodiment, controller 360 is configured to connect with speaker units 300 and 301 to direct and control output of audio data.

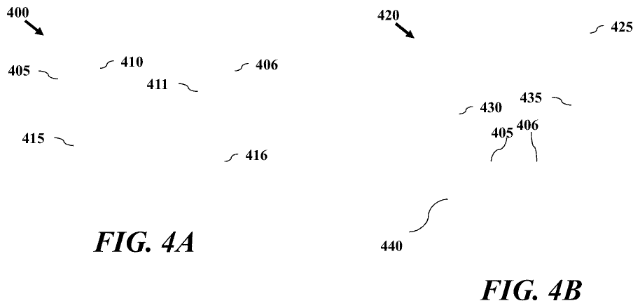

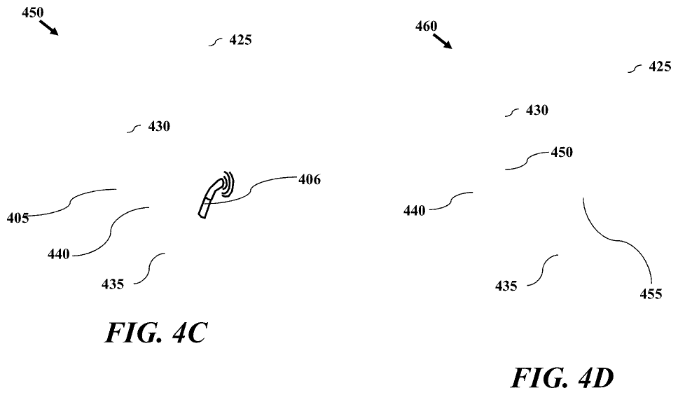

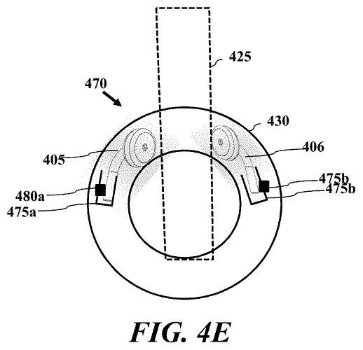

FIG. 4A depicts a graphical representation of an earphone pair according to one or more embodiments. According to one embodiment, second speaker system 400 includes an earphone pair including earphones 405 and 406. Each earphone may include a speaker and housing. Earphone 405 includes speaker 410 and housing 415. Earphone 406 includes speaker 411 and housing 416. According to one embodiment, earphones 405 and 406 may operate independently from a head set unit to receive audio data then sound by way of speakers 410 and 411. Earphones 405 and 406 including housings 415 and 416 having a shaft portion that is configured to engage with the inner portion of the headset ear cups. Housings 415 and 416 may also allow for the earphones 405 and 406 to engage and/or be retained by an outer portion of the headset ear cups.

Earphones 405 and 406 are configured to separate from the headset apparatus and be used independently to enhance portability and mobility during use.

FIG. 4B depicts a graphical representation of a headphone system including a headset unit and earphone pair according to one or more embodiments. Headset unit 420 includes headband 425 and ear cups 430 and 435. Headset unit 420 is an over the ear headset. Ear cups 430 and 435 include an inner portion that allows a user's ear to be covered by the ear cup. In certain embodiments, ear cups 430 and 435 may be on ear elements. According to one embodiment, headset unit 420 is configured to retain a second speaker system, such as an earphones 405 and 406 (e.g., earphone pair) within ear cups 430 and 435. Headset unit 420 may include one or more of a slot, coupling, and retaining element to securing mount earphones 405 and 406 within ear cups 430 and 435. In one embodiment, earphones 405 and 406 are mountable within ear cups 430 and 435 such that the earphones 405 and 406 are secured by the headset and inserted into a user's ear. In alternative embodiments, earphones 405 and 406 are mountable within ear cups 430 and 435 to be near the ears of the wearer.

Each ear cup includes an outer portion, shown as 440 for ear cup 430. In certain embodiments, an outer portion of the ear cups may be configured to retain or mount earphones 405 and 406.

FIG. 4C depicts a graphical representation of a headphone system including a headset unit and earphone pair according to one or more other embodiments. Headset unit 450 includes headband 425 and ear cups 430 and 435. Headset unit 450 is an over the ear headset including mounting areas for earphones 405 and 406 on an outer surface (e.g., surface 440) of ear cups 430 and 435. Headset 450 may be another embodiment of headset 420, and operate in a similar fashion to allow for selection of headset speaker elements and earphones 405 and 406. According to one embodiment, headset 450 is configured to charge earphones 405 and 406 when coupled to the outer portion 440. Headset may include one or more structural elements, such as a slot, fastener, and retaining means in addition to an electrical connection to the power source of earphones 405 and 406. In one embodiment, earphones 405 and 406 are charged on separate ear cups. According to another embodiment, earphones 405 and 406 may be charged on the same ear cup as will be described with reference to FIG. 4E below.

FIG. 4D depicts a graphical representation of a headset unit of a headphone system according to one or more other embodiments. Headset unit 460 includes headband 425 and ear cups 430 and 435. According to one embodiment, openings 450 and 455 of ear cups 430 are configured to provide an over the ear fit when earphones 405 and 406 are worn, or without earphones 405 and 406. According to one embodiment, when worn over earphones 405 and 406 headset may function to reduce external noise by way of passive noise filtering and/or active filtering. According to another embodiment, headset 460 may include speakers in openings 450 and 455 and may be worn with and without earphones 405 and 406.

According to one embodiment headset 460 enhances the ability to listen to audible sound while minimizing unwanted ambient noise as the over the ear elements may block and/or suppress environmental noise.

FIG. 4E depicts a graphical representation of a headset unit configuration of a headphone system according to one or more other embodiments. According to one embodiment, headset unit 470 is configured to retain both speaker drivers of the earphone pair within one ear cup unit, shown as ear cup 430. FIG. 4E illustrates a configuration that allows for removable attachment of both earphone speakers, such as earphones 405 and 406, onto the external surface of only one ear cup of headset 470. Headset 470 may relate to another configuration of the headset 450 of FIG. 4C according to another embodiment.

According to an exemplary embodiment, headset 470 includes ear cup 430 which is supported by headband 425. FIG. 4E shows a side profile of headset unit 470. According to another embodiment, ear cup 430 includes a first support, such as support 475a, and a second support, such as support 475b. Supports 475a-475b are each configured to retain an earphone speaker, such as earphones 405 and 406. According to one embodiment, each of supports 475a-475b include at least one of a slot, clip, and retainer configured to secure a section, such as the base, shaft, housing, and/or body, of an earphone speakers (e.g., earphones 405 and 406). Supports 475a-475b may relate to features molded into the outer surface of ear cup 430. According to another embodiment, headset unit 470 is configured to include at least one contact, such as contacts 480a-480b, configured to electrically charge earphones 405 and 406 when docked to ear cup 430. Contacts 480a-480b may be electrically connected to a power source (e.g., power source 365) of headset unit 470. According to an exemplary embodiment, earphones 405 and 406 may be used to listen to audio content (either while separated from or in combination with headset unit 470) and then can both be plugged into ear cup 430 (e.g., one ear cup) of headset unit 470 to charge, while still having the ability to use the ear cups of headset unit 470 to listen to audio as earphones 405 and 406 charge. As such, headset unit 470 is configured to charge earphone pair of earphones 405 and 406 when mounted ear cup 430 of headset unit 470. Headset unit 470 may also be configured to charge earphones 405 and 406 when mounted ear cup 430 while headset 470 is not in use to output audio.

While this disclosure has been particularly shown and described with references to exemplary embodiments thereof, it will be understood by those skilled in the art that various changes in form and details may be made therein without departing from the scope of the claimed embodiments.

What is claimed is:

1. A headphone speaker system, the system comprising:
a headset unit including a first speaker system, wherein the headset unit is an over the ear headset including a pair of ear cup units to house the first speaker system;
a second speaker system including an earphone pair; and
a control unit configured to direct audio output to at least one of the first speaker system and the second speaker system.

2. The system of claim 1, wherein the headset unit includes a speaker driver in each of the ear cup units, and wherein the headset unit is configured to emit sound from the speaker driver in each of the ear cup units.

3. The system of claim 1, wherein the headset unit is configured to retain each speaker driver of the earphone pair within a respective ear cup unit.

4. The system of claim 1, wherein the headset unit is configured to charge the earphone pair when mounted to the headset unit.

5. The system of claim 1, wherein the headset unit includes a mount configured to retain the second speaker system to an external surface of the ear cups.

6. The system of claim 1, wherein the second speaker system is configured for independent operation relative to the headset unit.

7. The system of claim 1, wherein the control unit directs audio output to both the first speaker system and the second speaker system, and wherein the first speaker system and second speaker system each emit sound.

8. The system of claim 1, wherein the control unit is configured to direct audio output to the second speaker system when the earphone pair is mounted within the ear cup units.

9. The system of claim 1, wherein the control unit directs audio output to the first speaker system when the earphone pair of the second speaker system is mounted to an external surface of the ear cup units.

10. A headphone speaker system comprising:
an earphone speaker system including an earphone pair, the earphone speaker system including a control unit configured to direct audio output to the earphone pair; and
a headset unit, wherein the headset unit is an over the ear headset including a pair of ear cup units, and wherein the headset unit is configured to removably retain the earphone speaker system within the pair of ear cup units.

11. The system of claim 10, wherein the headset unit includes a speaker driver in each of the ear cup units, and wherein the headset unit is configured to emit sound from the speaker driver in each of the ear cup units.

12. The system of claim 10, wherein the headset unit is configured to retain each speaker driver of the earphone pair within the pair of ear cups.

13. The system of claim 10, wherein the headset unit is configured to charge the earphone pair when mounted to the headset unit.

14. The system of claim 10, wherein the headset unit includes a mount configured to retain the second speaker system to an external surface of the ear cups.

15. The system of claim 10, wherein the second speaker system is configured for independent operation relative to the headset unit.

16. The system of claim 10, wherein the control unit directs audio output to both the headset speaker system and the earphone speaker system, and wherein the headset speaker system and earphone speaker system each emit sound.

17. A headphone speaker system, the system comprising:
a headset unit including a first speaker system and a first control unit,
wherein the headset unit is an over the ear headset including a pair of ear cup units to house the first speaker system, and
wherein the first control unit is configured to direct audio output to the first speaker system; and
a second speaker system including an earphone pair and a second control unit, the second control unit is configured to direct audio output to the second speaker system,
wherein the first control unit and second control unit coordinate audio output for the headphone speaker system.

18. The system of claim 17, wherein the headset unit includes a speaker driver in each of the ear cup units, and wherein the headset unit is configured to emit sound from the speaker driver in each of the ear cup units.

19. The system of claim 17, wherein the headset unit is configured to retain each speaker driver of the earphone pair within a respective ear cup unit.

20. The system of claim 17, wherein the first control unit and second control unit direct audio output based on an arrangement of the earphone pair relative to the headset unit.
